(19) United States
(12) Patent Application Publication
(10) Pub. No.: US 2008/0108510 A1
(43) Pub. Date: May 8, 2008

(54) Method for estimating error from a small number of expression samples

(76) Inventor: Edward Thayer, (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/592,006

(22) Filed: Nov. 2, 2006

(51) Int. Cl. C40B 30/02

(52) U.S. Cl. 506/8

(57) ABSTRACT

A method for estimating error in expression data. In one embodiment, the method includes single molecule sequencing a plurality of expression tags from an organism; removing expression tags that ambiguously relate to multiple genes; assigning each remaining expression tag to a respective gene; selecting a random subset of the expression tags; and counting the number of expression tags associated with each gene. The process of selecting a random subset of the expression tags; and counting the number of expression tags associated with each gene is repeated a predetermined number of times, both for expression tags sequenced before and after exposure of the organism to a perturbation. The method also includes the step of calculating a measure of error in response to the counts of the number of expression tags before and after the perturbation.

### FIELD OF THE INVENTION

The invention relates generally to the field of bioinformatics and more specifically to determining error from a small number of samples of expression data.

### BACKGROUND OF THE INVENTION

Changes in gene expression are frequently used to determine whether a perturbation, such as the introduction of a drug, has a physiologic effect on a cell. In addition to determining whether a stimulus elicits a biological response, changes in mRNA expression can reveal which genes are active in response to a stimulus, and the ways in which genes interact in order to produce a biological response.

One of the key issues in correlating expression levels with biologic outcome is to determine confidence in the result of a measurement of expression. Typically, confidence levels are established by repeating a measurement multiple times in order to obtain a set of results that are amenable to statistical analysis and error calculation. Repeating measurements is expensive and time-consuming. Thus, there is a need in the art for a reliable manner of determining the reliability of gene expression analysis with the requirement of a large number of tests.

The present invention addresses this need.

### SUMMARY OF THE INVENTION

The invention provides methods for estimating error in measurements of single molecule gene expression data without requiring multiple de novo measurements. Single molecule sequencing involves the deposition of nucleic acids on a surface such that at least a portion, ideally substantially all, of the nucleic acids are individually optically resolvable. Template-dependent sequencing-by-synthesis is then conducted using duplex formed from either support-bound primer or template. In some cases, both primer and template are support-bound. The invention comprises obtaining single molecule RNA (or cDNA transcript) duplexes on a surface in an individually-optically resolvable configuration. Sequencing of some or all of the individual duplexes, depending upon the purpose of the experiment, is conducting in a template-dependent fashion in order to produce a plurality of sequence “tags” representing individual RNA (or cDNA) molecules present on the surface. Preferably, sequencing is conducted using optically-detectable labels as taught in co-owned, co-pending U.S. Ser. No. 11/481,403, the entirety of which is incorporated by reference herein. Tags assignable to a unique gene are pooled, and multiple representative samples, each comprising a subset of tags in the pool, are obtained and the number of copies of each unique sequence is determined. Next, a biological sample from which the population of mRNA is obtained is treated with an agent; and the sequencing, pooling, and sampling process is repeated. Differences in the copy number of individual RNAs are noted.

In one embodiment, the invention relates to a method for estimating error in gene expression data obtained from a plurality of biological samples through single-molecule sequencing methods. For example, the invention comprises obtaining a plurality of pre-perturbation expression tags through single molecule sequencing of mRNA from an organism, removing tags that ambiguously relate to multiple genes, and assigning each of the remaining tags to a gene. Then, multiple subsets of those remaining tags are chosen and counted. Then, a stimulus is applied and a plurality of post-perturbation expression tags is obtained through single molecule sequencing. Post-perturbation expression tags that ambiguously relate to multiple genes are then removed, and each of the remaining tags is assigned to a gene. Finally, multiple subsets of those remaining post-perturbation expression tags are counted, and a measure of error is calculated.

Thus, methods of the invention provides a novel form of bootstrapping in which a plurality of single measurements are made in order to determine the error space around gene expression analysis. The type of error is immaterial to the performance of methods of the invention. For example, the detected error may be a counting error or may be an expression of copy number counting errors in the context of a single gene, as shown, for example, by:

Log2(count of tags post-exposure for the gene)/count of tags pre exposure for the gene)

### Other objects of the invention are provided below in the Detailed Description thereof.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

When a gene is active, messenger ribonucleic acid (mRNA) is produced as a precursor to protein synthesis. Therefore by measuring mRNA one can indirectly determine that the gene encoding the mRNA is transcriptionally active. By measuring the mRNA present before and after exposure of a cell or organism to a perturbation such as a chemical agent or environmental change, one can determine which mRNA is present and hence which gene expression has been altered by the exposure. Single molecule techniques offer the additional advantage of being able to count the copy number of each individual mRNA (differentiated by sequence) in a high-throughput manner without amplification bias.

In general, small fragments of mRNA, ranging in size between about 20 bp and about 100 bp are polyadenylated, either enzymatically (e.g., using terminal transferase or another appropriate enzyme) or by ligation. The resulting polyadenylated fragments are hybridized to a poly-thymidine primer that has been attached to an epoxide-coated surface by direct amine attachment.

Next, single nucleotides (A, C, T, G) are introduced, one nucleotide species at a time. Each species carries a fluorophore that will fluoresce when excited by the appropriate wavelength of light. After each fluorescently-labeled nucleotide is introduced onto the sample surface, along with the appropriate polymerase mixture and allowed to react, the surface is then washed to remove any nucleotide that has not be incorporated into the primer. Only a nucleotide that is complementary to the next nucleotide of the template adjacent the 3′ terminus of the primer will be incorporated, the rest will be washed away.

The surface is exposed to light capable of exciting the fluorophore. If the last added nucleotide is incorporated into the chain, the incorporated nucleotide in the chain will fluoresce. If the nucleotide is not incorporated, no fluorescence will be detected. Fluorescent light is detected by, for example, a CCD camera which has the appropriate filters in place to permit only fluorescent light excited by the stimulus to reach the CCD camera. Next, if another fluorescent nucleotide is to be incorporated, the fluorophore on the incorporated nucleotide is cleaved and capped. The next nucleotide species with attached fluorophore is then added and the cycle is repeated.

By keeping track of which nucleotide is added to each duplex position by noting the incorporated fluorescence captured by the CCD camera, the sequence of nucleotide bases complementary to the attached fragment is determined. That sequence data may be combined with the sequence data from other fragments to thereby sequence the entire mRNA molecule of the sample or genome.

Each sequence tag is correlated to a gene. If a tag can represent more than one gene, it is considered ambiguous and disregarded. Additionally a tag can be considered to be ambiguous for other reasons, such as the potential for mis-reading the sequence due to bias in the instrument. Regardless of the criteria by which a tag is determined to be ambiguous, once it is defined as ambiguous, it is removed from the data set and not used in the calculations.

To determine the error and hence the significance of the changes in measurement of mRNA from a sample after the exposure to an agent or other metabolic perturbation, the tags remaining after the ambiguous tags are removed become the sample set that is subjected to a statistical “bootstrapping” analysis to determine the error. In a bootstrap analysis, from this set of non-ambiguous tags, a predetermined number of tags are randomly picked with replacement. Each of the chosen tags is then correlated to a gene. For example, expression-tag-1 correlates to gene-1. Expression-tag-3 correlates to gene-1, etc. and a tag count is derived for each gene.

From this random collection of tags, the following table (Table 1) is generated for each random selection of tags.

### Pre-Perturbation Tag Count

TABLE 1

| | | |
|---|---|---|
| gene-1 | tag-1 | 3 |
| | tag-3 | |
| | tag-19 | |
| gene-2 | tag-2 | 5 |
| | tag-4 | |
| | tag-5 | |
| | tag-17 | |
| | tag-18 | |
| gene-3 | tag-6 | 1 |
| . . . | . . . | . . . |
| gene-n | | 0 |

Next, this series of steps is repeated multiple times, resulting in multiple estimates of the tag count associated with each gene. This permits the following table (Table 2) to be generated:

### Pre-Perturbation

TABLE 2
(based upon simulation)

| | gene-1 | Gene-2 | gene-3 | . . . | gene-n |
|---|---|---|---|---|---|
| selection | | | | | |
| #1 | 3 | 5 | 1 | . . . | 0 |
| #2 | 19 | 3 | 2 | | 1 |
| #3 | 20 | 19 | 12 | | 16 |
| . | . | . | . | | . |
| . | . | . | . | | . |
| . | . | . | . | | . |
| #m | 1 | 3 | 9 | | 20 |
| Ave. no. of | 18.56 | 10.22 | 12.06 | . . . | 18.98 |
| tags per gene | | | | | |
| Upper 95% | 16.09 | 17.26 | 9.87 | | 11.23 |
| confidence | | | | | |
| interval | | | | | |
| Lower 95% | 2.34 | 3.45 | 2.33 | | 1.21 |
| confidence | | | | | |
| interval | | | | | |

Thus in row one, gene-1 had three tags associated with it for the first selection of tags, gene-2 had five tags associated with it from the first selection of tags, and gene-3 had 1 tag associated with it from the first selection of tags, as shown in Table 1. This is then repeated for all m selections, each time assigning the tags picked with a corresponding gene.

As is routine in the application of bootstrapping techniques, the present invention teaches sorting each column by observed tag counts and selecting the 5th and 95th percentile counts for each in order to provide lower and upper confidence interval estimates for each gene tag count.

Next, the cell is exposed to a perturbation such as a drug. The process is then repeated for mRNA extracted after exposure to the drug. For each random selection of tags another table (Table 3) is then generated counting the post-perturbation tags associated with the genes. This table is similar to that in Table 1 for the pre-perturbation tags. Bootstrapping is performed on these tags in an identical fashion as in the pre-exposure sample to produce Table 4.

### Post-Perturbation Tag Count

TABLE 3

| | | Number of tags |
|---|---|---|
| Gene | Tags | correlated to gene |
| gene-1 | tag-1 | 2 |
| | tag-128 | |
| gene-2 | tag-1224 | 5 |
| | tag-144 | |
| | tag-520 | |
| | tag-117 | |
| | tag-118 | |
| gene-3 | tag-646 | 2 |
| | tag-789 | |
| . . . | . . . | . . . |
| gene-n | tag-99 | 1 |

### After Exposure to Perturbation

TABLE 4

| | gene-1 | gene-2 | gene-3 | . . . | gene-n |
|---|---|---|---|---|---|
| selection | | | | . . . | |
| #1 | 2 | 5 | 2 | . . . | 1 |
| #2 | 12 | 2 | 3 | . . . | 0 |
| #3 | 19 | 4 | 2 | . . . | 15 |
| . . . | . . . | . . . | . . . | . . . | . . . |
| #m | 20 | 19 | 2 | | 0 |
| Ave no. of | 15 | 20 | 6 | . . . | 12 |
| tags per gene | | | | | |

When differential expression is of interest, one routinely computes the log ratio:

Log2 (count of tags post-exposure for the gene/count of tags of pre-exposure for the gene)

for each gene under investigation. In such instances, one can estimate the error associated with each gene's relative (or differential) expression via a bootstrap method similar to that described above for counts.

Specifically, randomly sample with replacement rows from tables 2 and 4 above, and for each gene compute Log2 (count of tags post-exposure for the gene/count of tags of pre-exposure for the gene) and enter those values into Table 5. Repeat this random selection K times for each gene. As before, compute the mean, 5th and 95th percentile log2 ratio for each gene.

| Select | Gene-1 | . . . | Gene-n |
|---|---|---|---|
| #1 | −1.5 | | 2.1 |
| #2 | 3.0 | | 0.1 |
| #3 | 0.01 | | 0.02 |
| . | | | |
| . | | | |
| . | | | |
| #K | 0.51 | . . . | 1.23 |
| Ave Log₂ Ratio | 1.74 | | 1.34 |
| Lower 95^{th} % tile | 0.34 | | 0.75 |
| confidence interval | | | |
| Upper 95^{th} % tile | 1.96 | | 1.87 |
| confidence interval | | | |

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

1. A method for estimating error in expression data from a plurality of biological samples comprising the steps of:
a) obtaining a plurality of pre-perturbation expression tags through single molecule sequencing of mRNA from an organism;
b) removing pre-perturbation expression tags that ambiguously relate to multiple genes;
c) assigning each of the remaining plurality of pre-perturbation expression tags to a respective gene;
d) selecting a subset with replacement of the plurality of pre-perturbation expression tags;
e) counting the number of pre-perturbation expression tags that correspond to each gene within the subset selected in (d);
f) computing the mean, 5th percentile, and 95th percentile counts for each gene;
g) repeating steps d and f a predetermined number of times;
h) obtaining a plurality of post-perturbation expression tags through single molecule sequencing of mRNA from an organism after exposure to a perturbation;
i) removing post-perturbation expression tags that ambiguously relate to multiple genes;
j) assigning each of the remaining plurality of pre-perturbation expression tags to a respective gene;
k) selecting a subset with replacement of the plurality of the post-perturbation expression tags;
l) counting the number of post-perturbation expression tags that correspond to each gene within the subset selected in k;
m) repeating steps k and l a predetermined number of times;
n) in response to the expression tags measured both before and after exposure to the perturbation calculating a measure of error.

2. The method of claim 1 where the measure of error is a counting error.

3. The method of claim 2 wherein the counting error for a single gene is given by the expression:
Log2(count of tags post-exposure for the gene)/count of tags pre-exposure for the gene)
